(19) United States
(12) Patent Application Publication
(10) Pub. No.: US 2026/0309928 A1
(43) Pub. Date: Oct. 8, 2026

(54) Efficient Deployment of Large-Scale Network Nodes Using Pre-Installed Fiber Connectivity

(71) Applicant: Ciena Corporation, Hanover, MD (US)

(72) Inventors: Daniel Rivaud, Ottawa (CA); Fabien Colton, Kars (CA); Raymond Joseph Quintal, Stittsville (CA); Lloyd Cosman, Stittsville (CA)

(73) Assignee: Ciena Corporation, Hanover, MD (US)

(21) Appl. No.: 19/169,449

(22) Filed: Apr. 3, 2025

(51) Int. Cl. G02B 6/38; H04L 43/50

(52) U.S. Cl. CPC G02B 6/3885; H04L 43/50

(57) ABSTRACT

A large-scale network node includes network modules and Fiber Interface Modules (FIMs) with pre-installed intra-rack fiber connectivity utilizing multi-fiber cables and connectors. The node facilitates efficient deployment by enabling inter-rack connectivity through high-density fiber trunk cables connected between FIMs at the deployment destination. FIMs include connectors configured for simplified, rapid field installation and may utilize a straight-through or shuffled fiber lane arrangement to optimize cable management and scalability. A deployment method involves receiving pre-assembled racks at a destination, each rack containing pre-connected network modules and FIMs, and completing deployment by connecting inter-rack fiber trunk cables. The method further comprises arranging racks according to a blueprint, verifying connectivity, inspecting cable routing, and validating system performance.

### FIELD OF THE DISCLOSURE

The present disclosure generally relates to communications networks. More particularly, the present disclosure relates to large-scale network nodes and methods for streamlining a process of setting up the network nodes within a space-constrained area of a data center.

### BACKGROUND

Within a data center, an enterprise may deploy a network node having a large-scale architecture that includes many racks (e.g., cabinets, chassis, etc.). To set up the node, network equipment (e.g., network modules, Network Elements (NEs), routers, switches, “pizza box” type components, etc.) can be installed on the racks using various hardware elements, such as nuts and bolts. Once the network equipment is installed, network interface components (e.g., Small Form-factor Pluggable (SFPs), etc.) may be plugged into the various network modules. Also, thousands of fiber optic cables are typically connected between network modules on each rack as well as between modules located on different racks. For a large-scale node, this installation process, in addition to a process of labelling each of the cables, can be extremely time-consuming and might involve working in small tight spaces. A common complaint among installers and other network technicians is that the space within a data center (or similar network environment) is typically very limited and that there is insufficient staging space or floor space for handling equipment and cables. This can make installation more difficult and time-consuming. Therefore, there is a need to improve the entire process of installing network nodes in a data center.

### BRIEF SUMMARY

The present disclosure is directed to large-scale nodes deployed within a data center. According to one implementation, a large-scale network node may be arranged over multiple racks. Each rack, for instance, may include a plurality of network modules, intra-rack connectivity, inter-rack connectivity, and one or more Fiber Interface Modules (FIMs). Before the multiple racks are shipped to a destination where the large-scale network node is intended to operate, the network modules may be pre-installed on the corresponding racks with a first set of fiber cables associated with intra-rack connectivity being pre-connected among the network modules according to a blueprint of the large-scale network node. After the multiple racks are shipped to the destination and arranged according to the blueprint of the high-scale network node, a second set of fiber cables associated with inter-rack connectivity may be connected between the FIMs of different racks.

According to some embodiments, on each rack, the intra-rack connectivity may include Multi-fiber Push-On (MPO) cables and MPO connectors attached between the network modules and the one or more FIMs. Sets of the MPO cables and MPO connectors may be pre-connected between the network modules and the one or more FIMs on each respective rack before shipping. Also, the FIMs are configured to enable the inter-rack connectivity after shipping. The inter-rack connectivity may include Expanded Beam Optics (EBO) trunk cables and EBO connectors having a high fiber density per cable, wherein the EBO trunk cables, for example, may be EBO-144 cables having 144 fibers per cable, and the MPO cables may be MPO-16.

Each rack, for example, may include three FIMs, wherein each FIM may have a front section configured for the intra-rack connectivity with a front section of corresponding network modules, and wherein each FIM may have a back section configured for the inter-rack connectivity via an Expanded Beam Optics (EBO) connector. The destination where the large-scale network node is intended to operate, for example, may be a data center having a limited staging area. In some embodiments, the racks may be constructed at a third-party integrator facility where fiber ends of cables for intra-rack connectivity are cleaned in a sterile environment of the third-party integrator facility. The inter-rack connectivity, for example, may include fiber trunk cables and connectors that are constructed at the third-party integrator facility and shipped separately from the racks to the destination.

The blueprint described above may be configured to define a custom length of fiber trunk cables used for inter-rack connectivity, wherein the custom length may be based on a) a pre-calculated distance between FIMs on different racks, b) pre-planned arrangement of the racks at the destination, c) building and/or room characteristics of the destination, and d) a predetermined amount of slack. The large-scale network node may include a first group of racks that support network modules configured as fabric components and a second group of racks that support network modules configured as fabric interface or gateway components.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram showing a front perspective view of an empty network rack, according to some embodiments.

FIG. 2 is a system diagram showing a top view of an arrangement of racks in a data center, according to some embodiments.

FIG. 3 is a diagram illustrating a connectivity arrangement among network modules in a multi-rack network node, according to some embodiments.

FIG. 4 is a diagram illustrating another connectivity arrangement among network modules in a multi-rack network node, according to some embodiments.

FIGS. 5A and 5B are diagrams showing a front perspective view and a back perspective view of a vertically oriented Fiber Interface Module (FIM), according to some embodiments.

FIG. 6A-6D are diagrams showing a top view, front view, front perspective view, and back perspective view of a horizontally oriented FIM, according to some embodiments.

FIG. 7 is a diagram showing a front perspective view of a rack with multiple FIMs arranged either vertically or horizontally, according to some embodiments.

FIGS. 8A and 8B are diagrams showing front perspective views of the rack of FIG. 7 with vertically mounted FIMs arranged in connection with network modules installed on the rack, according to some embodiments.

FIGS. 9A and 9B are diagrams showing front views of the rack of FIG. 7 with the vertically mounted FIMs arranged in connection with the network modules installed on the rack, according to some embodiments.

FIG. 10A-10C are diagrams showing an example of three FIMs arranged vertically on the rack where each FIM is designated for connection with network modules positioned at different heights on the rack, according to some embodiments.

FIG. 11 is a diagram showing a front view of a vertically oriented FIM with a 3×3 array of connections for each of 16 different ports, according to some embodiments.

FIG. 12A-12C are diagrams showing back views of different FIM configurations for the 16 different ports, according to some embodiments.

FIG. 13A-13C are diagrams showing views of the vertically oriented FIM of FIG. 12A, according to some embodiments.

FIG. 14A-14C are diagrams showing views of the vertically oriented FIM of FIG. 12B, according to some embodiments.

FIG. 15 is a diagram showing a cross-sectional top view of a network module and a corresponding side plane FIM, according to some embodiments.

FIG. 16 is a diagram showing a cross-sectional top view of another network module and a corresponding side plane FIM, according to some embodiments.

FIG. 17A-17D are diagrams showing views of a rack equipped with network modules and side plane FIMs, according to some embodiments.

FIG. 18 is a flow diagram illustrating a method for deploying a multi-rack network node in a data center, according to some embodiments.

FIG. 19 is a flow diagram illustrating a method for deploying a deploying a large-scale network node, according to some embodiments.

### DETAILED DESCRIPTION

In various embodiments, the present disclosure relates to large-scale network nodes that are arranged over multiple racks (e.g., cabinets, chassis, etc.) in a data center or other communication network environment. The node may include as many as 20 racks (or more, in some cases). In order to manage connectivity between this high number of racks, the systems and methods of the present disclosure employ components referred to herein as Fiber Interface Modules (FIMs). These FIMs may assist with “intra-rack connectivity” to some extent. However, a more useful goal is to use the FIMs to simplify “inter-rack connectivity,” as explained in more detail in the present disclosure. The FIMs may be configured as passive optical elements having a plurality of multi-fiber connectors, wherein each connector can be connected to the FIM installed on another rack via a multi-fiber cable. In some cases, the FIMs may include a straight-through fiber connection or a shuffled fiber connection, whereby the shuffle function is configured to multiply the switch radix by up to half the number of MPO fibers. For example, MPO-16 would give a radix increase of 16/2=8×. The reason for the ‘half’ is that each channel consumes 2 fibers (Tx+Rx). So, a system with MPO-32 (e.g., Octal Small Form-factor Pluggable (OSFP) (OSFP-XD) plugs) would see a radix increase of 16×. Also, the radix could further be increased by having high-density cables (e.g., EBO-144) on both sides. This could further increase the radix, e.g., 72×, and could be used on switches with CPO (Co-Packaged Optics) technology rather than pluggable modules.

One challenge regarding the setup of such a large-scale network node is that there is generally a lack of sufficient staging space (e.g., room for packaging and unpacking) with respect to network equipment in the data center. In other words, setting up the large network node may require a large amount of floor space within the data center to enable the racks of the network node to be maneuvered into their proper positions and to enable cables to be properly connected.

Thus, according to the embodiments of the present disclosure, racks can be fully built out with intra-rack connectivity before the racks are shipped to the data center. Also, custom-designed high-capacity trunk cables can also be designed and built according to the layout of the network node within the known floorplan of the data center before these trunk cables are shipped to the data center. When the network equipment for creating the network node arrives at the data center, the installer can position the racks according to a pre-established blueprint of the node and then easily connect the pre-planned inter-rack trunk cables for connecting the network modules on multiple racks according to the blueprint.

Even with limited floor space, the installer can easily connect 60-120 connectors as opposed to tracing and connecting thousands or even tens of thousands of connectors, bundling the cables, labelling the connections, etc., which is normally expected of installers in a traditional setup plan. Having most (if not all) of the intra-rack connections pre-connected, before shipping to the data center, the installer can easily connect the bundled trunk cables according to the design. As such, the embodiments described in the present disclosure are configured to ship the pre-cabled, pre-positioned packages to thereby simply or minimize the manual labor of the installer's activities at the location where the network node is intended to operate (e.g., at the data center).

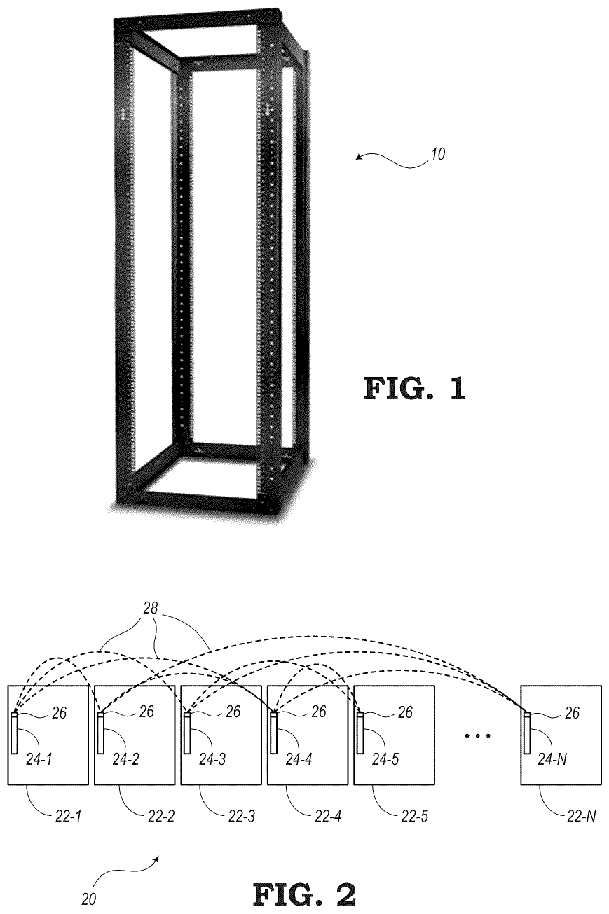

FIG. 1 is a diagram showing a front perspective view of an embodiment of an empty network rack 10. According to various embodiments, the empty network rack 10 may include any suitable height, width, and depth. In some cases, the empty network rack 10 may have a height of about 84 inches, a width of about 24 inches, and a depth of about 30 inches. In some embodiments, the empty network rack 10 may have space (i.e., height) of about 42 Rack Units (RUs) for accommodating a plurality of network modules. Of course, these are merely example values and various embodiments are contemplated with different values for height, width, and/or depth.

### Multi-Rack Network Node Layout

FIG. 2 is a schematic diagram showing an embodiment of a network node 20 arranged in a data center, shown essentially as a top view. As illustrated in FIG. 2, the network node 20 includes a simple arrangement in which a plurality of racks 22-1, 22-2, . . . , 22-N are placed in one row. It should be noted, however, that the network node 20 may have some racks 22 located in different rows within the data center and may even include some racks 22 positioned in different rooms and/or different buildings of the data center, depending on how the data center is configured and the available space within the data center for deploying the network node 20. Normally, it would be preferable to arrange all the racks 22 in proximity to each other, but sometimes this may not be possible based on availability within the data center or the way in which the data center is constructed. In some embodiments, the network node 20 may be a large-scale node, whereby the number (N) of racks 22 is about twenty.

Furthermore, the racks 22-1, 22-2, . . . , 22-N may each include sets of Fiber Interface Modules (FIMs) 24-1, 24-2, . . . , 24-N. As illustrated in FIG. 2, only the top most FIM 24 is shown in each rack 22, whereby one or more other FIMs 24 may be positioned below this FIM 24. In some embodiments, each rack 22 may include three FIMs 24. Also, a back portion of the FIMs 24 may include connectors 26 for connection with trunk cables 28 for interconnecting FIMs 24 positioned on different racks 22. In some embodiments, the trunk cables 28 may be Expanded Beam Optics (EBO) cables having corresponding EBO connectors.

The FIMs 24 may be oriented in an upright or vertical configuration along a side plane of the respective rack 22. Network components (e.g., network modules, Network Elements (NEs), switches, routers, Reconfigurable Optical Add Drop Multiplexers (ROADMs), transceivers, etc.) may be positioned (e.g., stacked) within each rack 22. Intra-rack fiber optic cables may be connected between the network modules and the FIMs 24. In some embodiments, fiber optical cables may be connected between a front (or face) portion of the network modules and a front portion of the FIMs 24. These cables may be configured as Multi-fiber Push-On (MPO) cables having MPO connectors configured for connection with corresponding MPO connectors on the network modules and FIMs 24.

In some embodiments, a group of MPO cables may be bundled into an exit grouping of MPO-16 pigtails, whereby the cables may be configured with custom lengths as appropriate so that there is no slack to deal with when connecting them to the network modules. In some embodiments, the network modules arranged on some racks 22 may be configured as internal fabric switching components (e.g., switching boxes or sbox), while the network modules arranged on other racks 22 may be configured as fabric interface switching components (e.g., interface boxes or ibox).

Furthermore, according to the node constructions strategies described in the present disclosure, the network modules arranged on each individual rack 22 may be pre-connected with MPO cables before the rack 22 is shipped to the data center. For example, these MPO cables and connectors may be installed at any suitable construction facility (e.g., a third party integrator) so that a full rack 22 with the FIMs 24 on the side planes may be shipped pre-cabled as a single unit to the data center. Once in the data center, only the trunk cables 28 (e.g., EBO connectors) have to be installed between the racks 22 based on the particular blueprint of the network node 20.

The FIMs 24 may be reversible and therefore may be positioned on either or both of the side planes of the racks 22. The FIMs 24 may be configured with a straight-through arrangement or a shuffled arrangement. In one respect, if there is a failure on one FIM 24, this may result in only a loss of one-fourteenth of the fabric of the network node 20, which in most cases can be tolerable and may not significantly disrupt operation.

It may be noted that the FIMs 24 are located within the borders of the rack 22 to minimize the footprint of the rack 22 within the data center. In other embodiments, however, one or more of the FIMs 24 may be located in separate sidecars or Vertical Cable Managers that are attached to the sides of the racks 22.

### Connectivity Arrangements

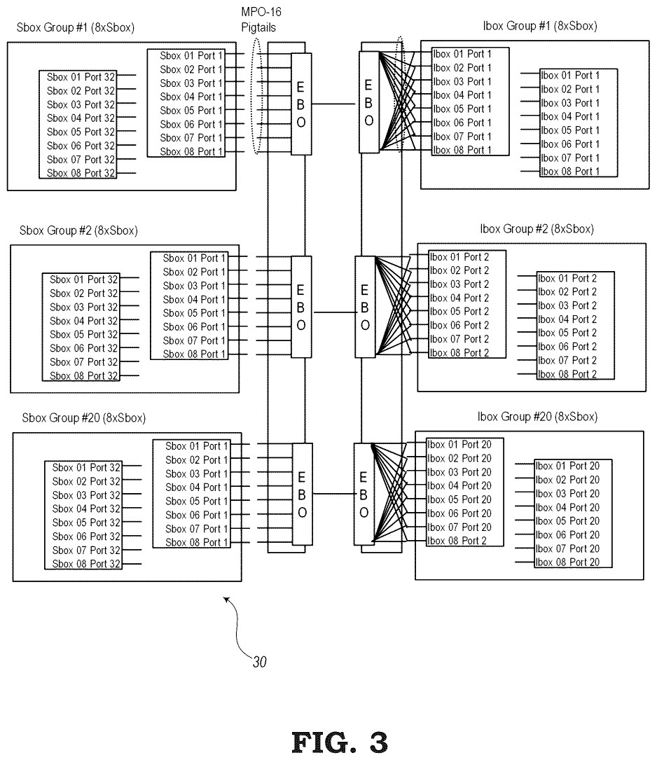

FIG. 3 is a diagram illustrating an embodiment of a connectivity arrangement 30 among network modules and racks within a multi-rack network node. As shown on the left side of FIG. 3, multiple groups of switching boxes (e.g., sbox groups #1-20), including ports #1-32, are connected via MPO-16 pigtail fiber cables to “sideplanes” #1-32 (e.g., FIMs) on one side (e.g., front facing side) of the FIMs. On the other side (e.g., back side) of the FIMs, EBO connectors are arranged. Similarly, on the right side of FIG. 3, multiple groups of interface boxes (e.g., ibox groups #1-32), include ports #1-20, are connected via MPO-16 pigtail fiber cables to sideplanes #1-32 (e.g., FIMs) on one side (e.g., front facing side) of the FIMs, while on the other side (e.g., back side) of the FIMs, EBO connectors are arranged. The FIMs (or “sideplanes”) associated with the switching boxes include straight-through connectivity, while the FIMs (or “sideplanes”) associated with the interface boxes include a shuffled connectivity.

The racks (with sideplanes) may include the network modules (e.g., sbox, ibox, etc.) with the MPO cables already installed therein. The racks can be shipped to the data center (or other facility) where the network node is intended to be deployed and put into operation. After the racks are shipped to the data center and arranged according to the design of the network node, the EBO trunks (shown in the middle of FIG. 3) can then be connected to the EBO connectors, where one EBO connector at one end is connected to the EBO connector of the switching boxes and an EBO connector at the other end is connected to the EBO connector of the interface boxes.

Although sbox and ibox are depicted in this example, it should be noted, however, that any suitable network modules may be included in various embodiments and arrangements of the network nodes. In some embodiments, the network modules may include Graphical Processing Unit (GPU) components to various network equipment. A radix multiplication, pre-cabled, compact footprint, and low-labor EBO installation provides substantial benefits to GPU clusters.

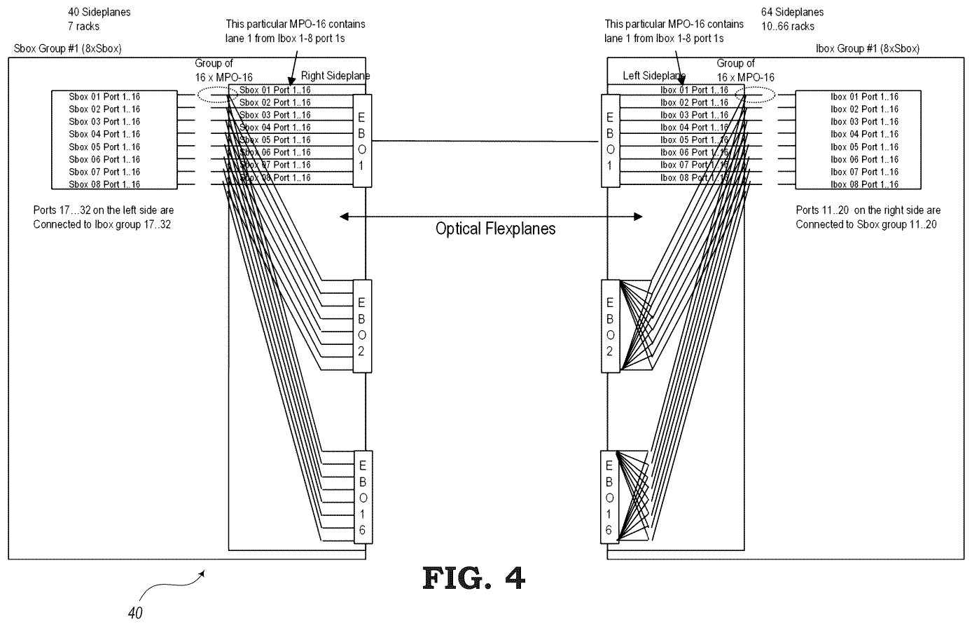

FIG. 4 is a diagram illustrating an embodiment of another connectivity arrangement 40 among components in a multi-rack network node. The embodiment of FIG. 4 includes many similarities to the embodiment of FIG. 3. Also, as with the embodiment of FIG. 3, the EBO cables may extend up to 300 m if necessary, depending on the arrangement of the racks within the data center.

### Fiber Interface Modules (FIMs)

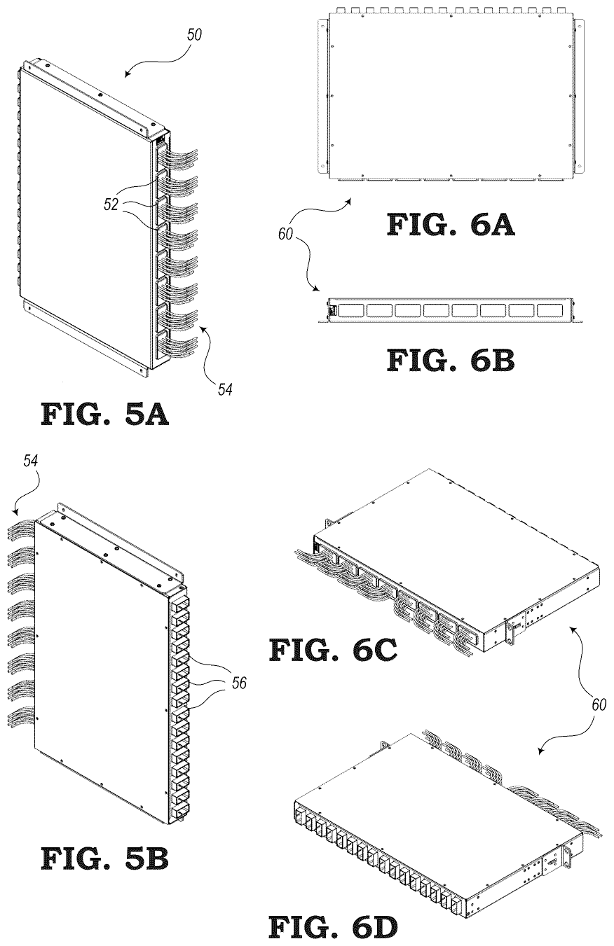

FIGS. 5A and 5B are diagrams showing a front perspective view and a back perspective view of an embodiment of a vertically oriented Fiber Interface Module (FIM) 50. The front portion of the FIM 50 includes eight connectors 52, each including a 3×3 array of ports. The ports may be connected to individual ports of network equipment or network modules via cables 54. The back section of the FIM 50 may include sixteen EBO connectors 56. As shown in FIGS. 5A and 5B, the connectors 52 may be pre-connected to the network modules during construction of the rack, while the EBO connectors 56 are initially not connected during construction. After shipping the racks to the final destination (e.g., data center), the installer may connect the EBO connectors 56 to the corresponding connectors of EBO cables leading to other FIMs on other racks. The height of the FIM 50 may be equivalent to about 10 RUs such that the cables 54 can be connected to eight to ten network modules arranged substantially next to the FIM 50. In some embodiments, three vertically oriented FIMs 50 could be installed along a side plane extending from a top of the rack to the bottom to easily connect with network modules on the rack.

FIG. 6A-6D are diagrams showing a top view, a front view, a front perspective view, and a back perspective view, respectively, of an embodiment of a horizontally oriented FIM 60. The FIM 60 may include the same features as the FIM 50, except for mounting elements used to mount the FIM 60 in a horizontal orientation as opposed to a vertical orientation. In this example, the horizontal configuration may allow the FIM 60 (or multiple similar FIMs) to be arranged at a top unused section of a rack. In this case, longer cables may be needed to extend from each network module on the rack up to the upper shelf oriented horizontal FIM 60. In some embodiments, the MPO fiber lengths could be modified to accommodate bottom or mid-cabinet installations as well.

The configuration of the FIMs 50, 60 may be similar so as to allow installation in either the vertical or horizontal mounting configurations to thereby provide flexibility in the design as may be appropriate for each customer. The FIMs 50, 60 may have a height/width of about 10 RU, a width/heigh of 1 RU, and a depth of 300 mm. In some embodiments, the rear side EBO connector quantity may be ten or sixteen, depending on various factors. The front side MPO connector groupings and fiber quantities may depend on the type of FIM being used (e.g., groups of 10 or 16). The mechanical kit may be unique for horizontal versus vertical installs, due to differences in mounting brackets.

Where space is available in the cabinet, the FIM 50, 60 can be mounted vertically next to the equipment. However, certain cabinet designs may not have adequate clearance on either side of the equipment mounting rails. As such, mounting horizontally may be a supported alternative mounting method. EBO-144 cables may be configured to enter the rear of the cabinet and be connected to the FIMs 50, 60 during setup of the network node at the data center.

### Racks With Fims

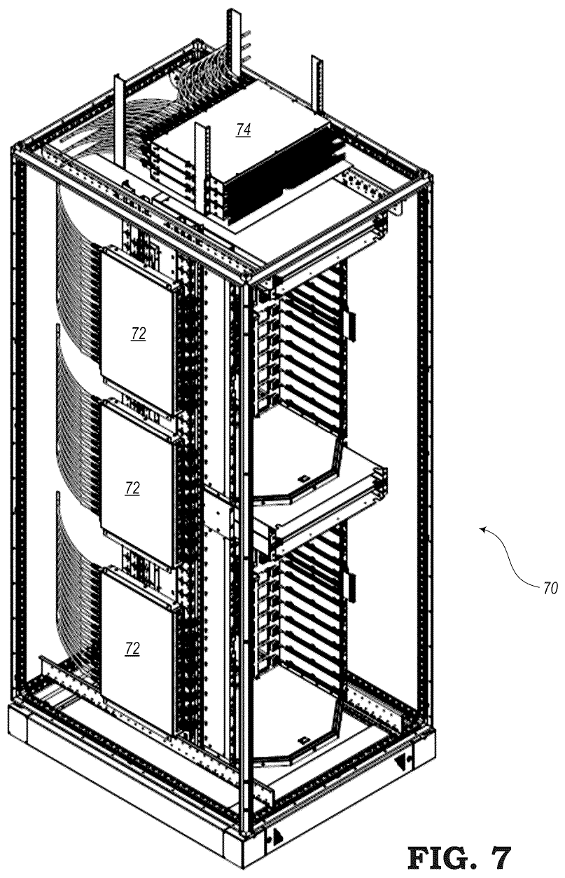

FIG. 7 is a diagram showing a front perspective view of an embodiment of a rack 70 with multiple FIMs 72 arranged on a side plane of the rack 70. Alternatively or additionally, FIMs 74 may be arranged in a stacked configuration at a top section of the rack 70 or on a shelf of the rack 70 that extends above the boundary of the rack 70 itself. A fibering analysis can be conducted for each design of a network node to determine whether FIMs 72 and/or FIMs 74 might be best utilized when installed on the side or top of the rack 70. Thus, the FIMs 72, 74 could be installed in the rack 70 in such a way that allows each MPO grouping of fibers to be identical (between groups), whereby each group of 10 or 16 fibers would have approximately 8 unique fiber lengths (per group), but those lengths would be repeated for each subsequent group allowing for efficient FIM fabrication and reduced cost.

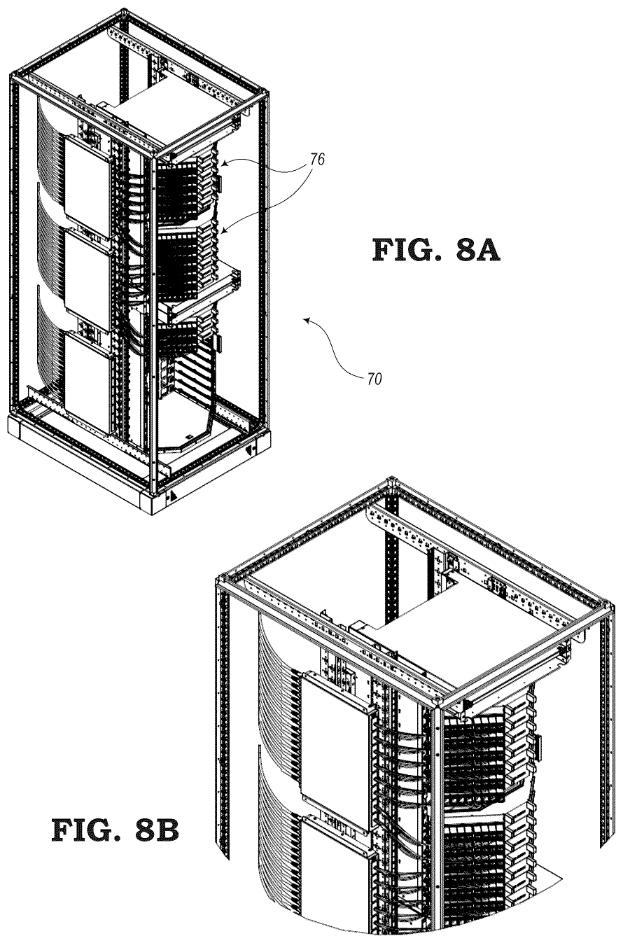

FIGS. 8A and 8B are diagrams showing front perspective views of an embodiment of the rack 70 of FIG. 7 with the vertically mounted FIMs 72 arranged in connection with network module 76 installed on the rack 70. The spacing between the three FIMs 72 may be adequate to maintain substantially equivalent MPO fiber lengths between the network modules 76 and the FIMs 72. As shown, the top and middle FIMs 72 may be routed to OSFP client boxes. Since each group of 10 or 16 fibers are routed to the same card, this makes for an easy installation in SIF (or at customer site), with a clean fibering solution when everything is installed. Fiber support hooks may be used in some cases, which may be part of a customized solution for some customers.

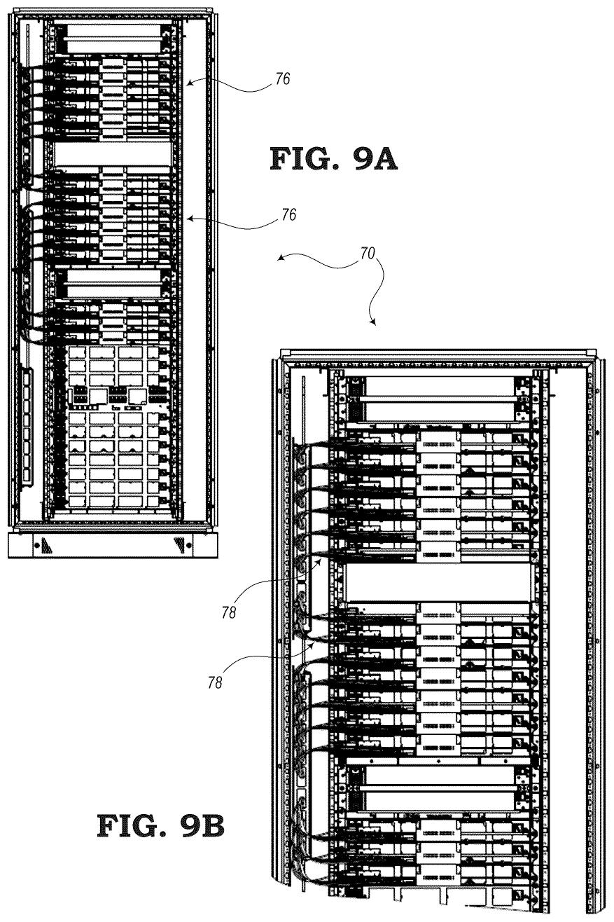

FIGS. 9A and 9B are diagrams showing front views of the rack 70 of FIG. 7 with the vertically mounted FIMs arranged in connection with the network equipment installed on the rack 70. Additional network modules may be added to a bottom portion of the rack 70 and connected to the bottom most FIM in some cases. MPO cables 78 are also shown in this figure.

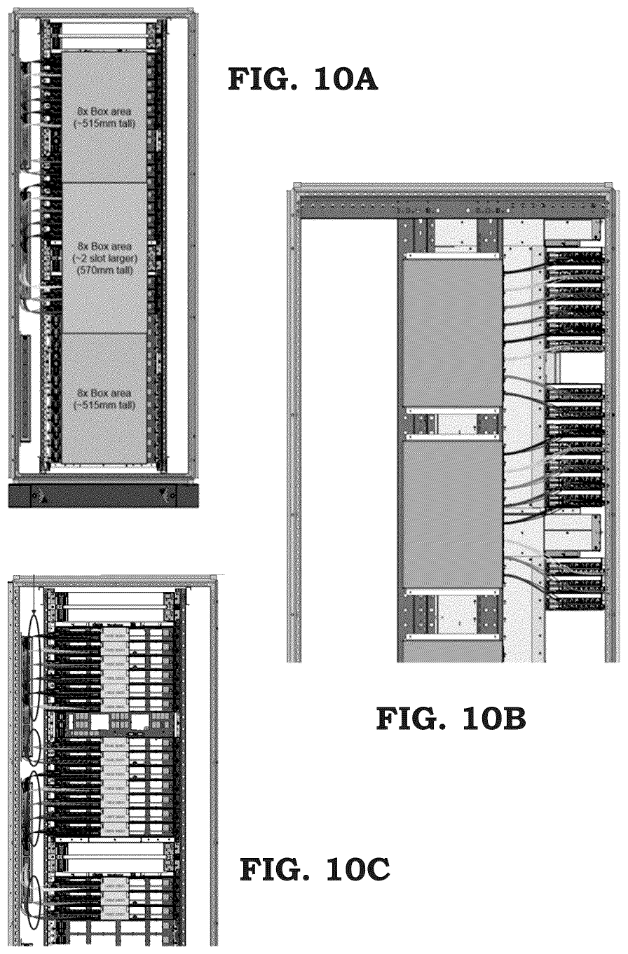

FIG. 10A-10C are diagrams showing different views of an embodiment of three FIMs arranged vertically on the rack, where each FIM is designated for connection with respective portions of the network equipment. Fiber length analysis, for example, may be performed to determine that between a top FIM and a middle FIM, the fiber lengths are nearly identical in all situations. The slight variation and fiber slack can be handled during fiber dressing. Alternative FIM designs may also be explored. In some embodiments, for example, a 14 RU tall×1 RU wide FIM (when arranged vertically) may be used. In some cases, the FIM may be 1.5 RU wide, depending on the faceplate layout. In a similar concept, in a different implementation, additional rack fibers and power cabling space layout may be used. Note, here and in other areas in the description, three FIMs are shown merely for illustrative purposes and other values are contemplated.

Therefore, according to various embodiments of the present disclosure, a large-scale network node may be arranged over multiple racks. Each rack, for instance, may include a plurality of network modules, intra-rack connectivity, inter-rack connectivity, and one or more Fiber Interface Modules (FIMs). Before the multiple racks are shipped to a destination where the large-scale network node is intended to operate, the network modules may be pre-installed on the corresponding racks with a first set of fiber cables associated with intra-rack connectivity being pre-connected among the network modules according to a blueprint of the large-scale network node. After the multiple racks are shipped to the destination and arranged according to the blueprint of the high-scale network node, a second set of fiber cables associated with inter-rack connectivity may be connected between the FIMs of different racks.

According to some embodiments, on each rack, the intra-rack connectivity may include Multi-fiber Push-On (MPO) cables and MPO connectors attached between the network modules and the one or more FIMs. Sets of the MPO cables and MPO connectors may be pre-connected between the network modules and the one or more FIMs on each respective rack before shipping. Also, the FIMs are configured to enable the inter-rack connectivity after shipping. The inter-rack connectivity may include Expanded Beam Optics (EBO) trunk cables and EBO connectors having a high fiber density per cable, wherein the EBO trunk cables, for example, may be EBO-144 cables having 144 fibers per cable.

Each rack, for example, may include three FIMs, wherein each FIM may have a front section configured for the intra-rack connectivity with a front section of corresponding network modules, and wherein each FIM may have a back section configured for the inter-rack connectivity via an Expanded Beam Optics (EBO) connector. The destination where the large-scale network node is intended to operate, for example, may be a data center having a limited staging area. In some embodiments, the racks may be constructed at a third-party integrator facility where fiber ends of cables for intra-rack connectivity are cleaned in a sterile environment of the third-party integrator facility. The inter-rack connectivity, for example, may include fiber trunk cables and connectors that are constructed at the third-party integrator facility and shipped separately from the racks to the destination.

The blueprint described above may be configured to define a custom length of fiber trunk cables used for inter-rack connectivity, wherein the custom length may be based on a) a pre-calculated distance between FIMs on different racks, b) pre-planned arrangement of the racks at the destination, c) building and/or room characteristics of the destination, and d) a predetermined amount of slack. The large-scale network node may include a first group of racks that support network modules configured as fabric components and a second group of racks that support network modules configured as fabric interface or gateway components.

### Various Embodiments of FIMs

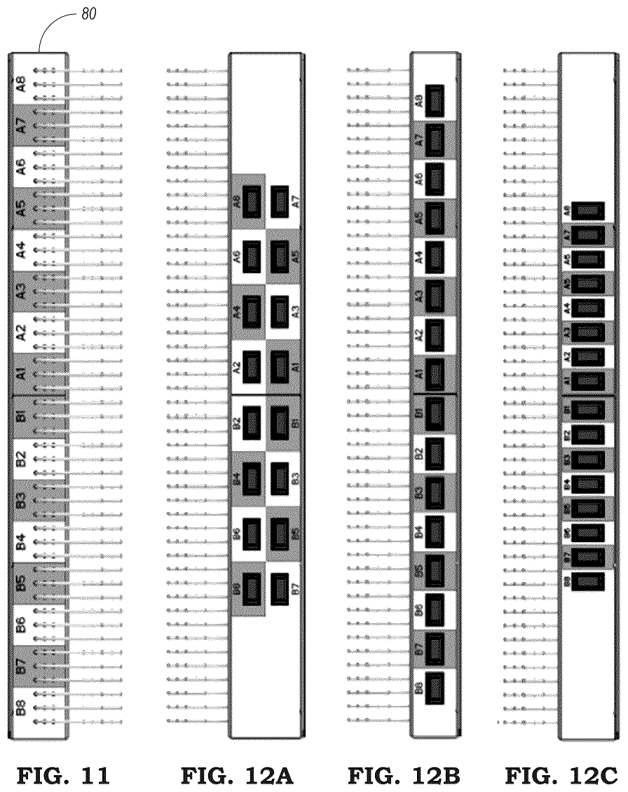

FIG. 11 is a diagram showing a front view of an embodiment of a vertically oriented FIM 80. In this embodiment, each of the areas labelled A1-A8 and B1-B8 contains a 3×3 array of MPO pigtails.

FIG. 12A-12C are diagrams showing back views of the FIM 80 according to various embodiments. In FIG. 12A, the back section of the FIM 80 includes sixteen EBO connectors where EBO connectors A1-A8 are arranged in a 2×4 array and EBO connectors B1-B8 are arranged in a 2×4 array. In combination, the sixteen EBO connectors form a 2×8 array. In FIG. 12B, the back section of the FIM 80 includes sixteen EBO connectors arranged linearly in a low-profile configuration. In FIG. 12C, the back section of the FIM 80 includes sixteen EBO connectors arranged linearly in a parallel configuration. In the embodiment of FIG. 12A, the width of the FIM 80 may be about 1.5 RU. In the embodiment of FIG. 12B, the width of the FIM 80 may be about 1.0 RU. In the embodiment of FIG. 12C, the width of the FIM 80 may be about 1.25 RU.

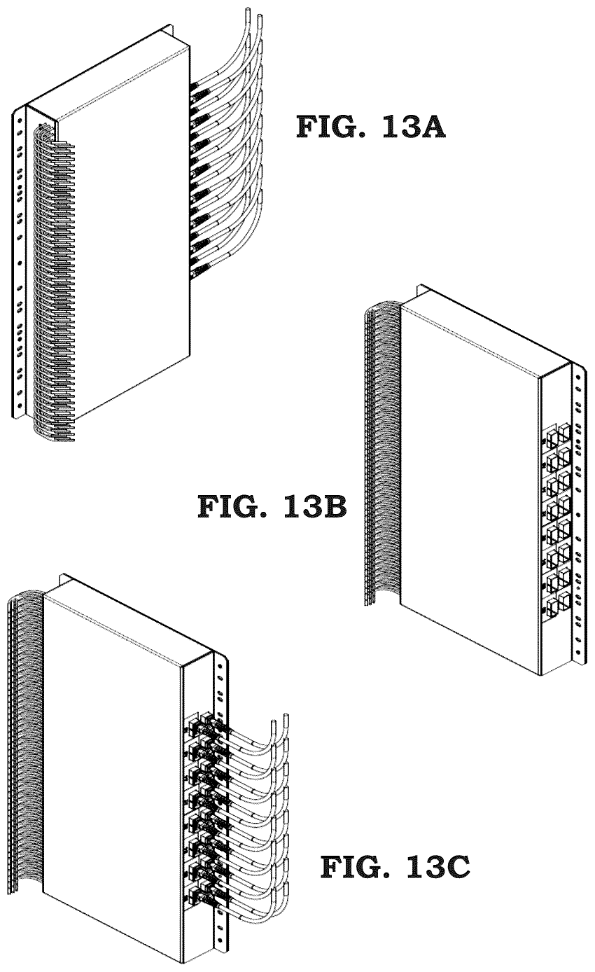

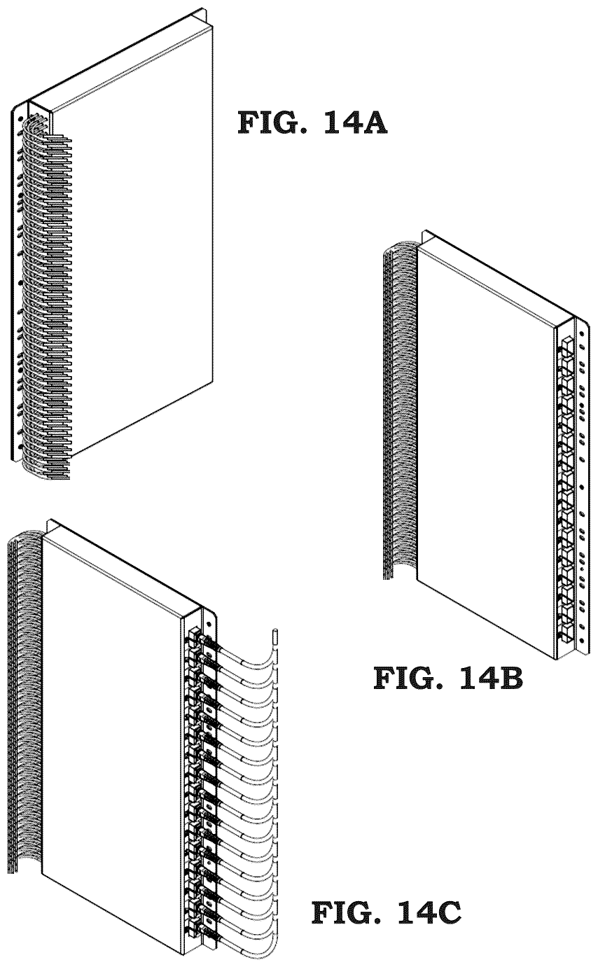

FIG. 13A-13C are diagrams showing views of an embodiment of another vertically oriented FIM. In some implementations, the FIM of FIG. 13A-13C may be the same as or similar to the embodiment shown in FIG. 12A. FIG. 14A-14C are diagrams showing views of another embodiment of a vertically oriented FIM. In some implementations, the FIM of FIG. 14A-14C may be the same as or similar to the embodiment shown in FIG. 12B.

In these additional FIMs, a cabinet layout analysis may be performed to determine fiber and power zones, when looking at the rack from the top. The FIM may be 14 RU tall. Again, the FIM (or side plane) may be a fully passive fiber solution. For example, the fibers can be fitted by hand, or an optical flex circuit can be printed with MPO-16 and EBO spliced onto it. The FIM may include a metal enclosure that protects the fibers therein so that fiber jacketing is not required.

According to various embodiments of the present disclosure, a Fiber Interface Module (FIM) may include an enclosure configured to be fixed to a rack of a multi-rack network node. The FIM may also include a first set of connectors attached to a first side of the enclosure, wherein the first set of connectors may be configured for intra-rack connection to a plurality of network modules mounted on the rack. Also, the FIM may include a second set of connectors attached to a second side of the enclosure, wherein the second set of connectors may be configured for inter-rack connection to one or more network modules mounted on one or more different racks of the multi-rack network node. Before the rack is shipped to a destination where the multi-rack network node is intended to operate, a first set of cables may be pre-attached to the first set of connectors. After the rack is shipped to the destination, a second set of cables may be configured to be attached to the second set of connectors.

In some embodiments, the first set of cables may be Multi-fiber Push-On (MPO) cables having connectors configured for attachment to the first set of connectors. The second set of cables, for example, may be Expanded Beam Optics (EBO) trunk cables having connectors configured for attachment to the second set of connectors. According to some embodiments, the enclosure may include either a) a straight-through fiber lane arrangement or b) a shuffle fiber lane arrangement connected between the first set of connectors and the second set of connectors, such that the enclosure may be configured to increase the switch radix of the multi-rack network node.

The enclosure may be a metal enclosure having a relatively flat box-shaped form-factor. In some embodiments, the enclosure may be arranged vertically on the rack in a side plane confined within a space defined within the dimensions of support members of the rack. The enclosure, when arranged vertically, may include a height of about 10 Rack Units (10 RUs) for connection with about 10 network modules arranged horizontally on the rack. Also, the destination where the large-scale network node is intended to operate may be a data center having a limited staging area. The rack, according to some embodiments, may be constructed at a third-party integrator facility, wherein fiber ends of the first set of cables may be cleaned in a sterile environment of the third-party integrator facility before being pre-attached to the first set of connectors.

### Additional Rack Configurations

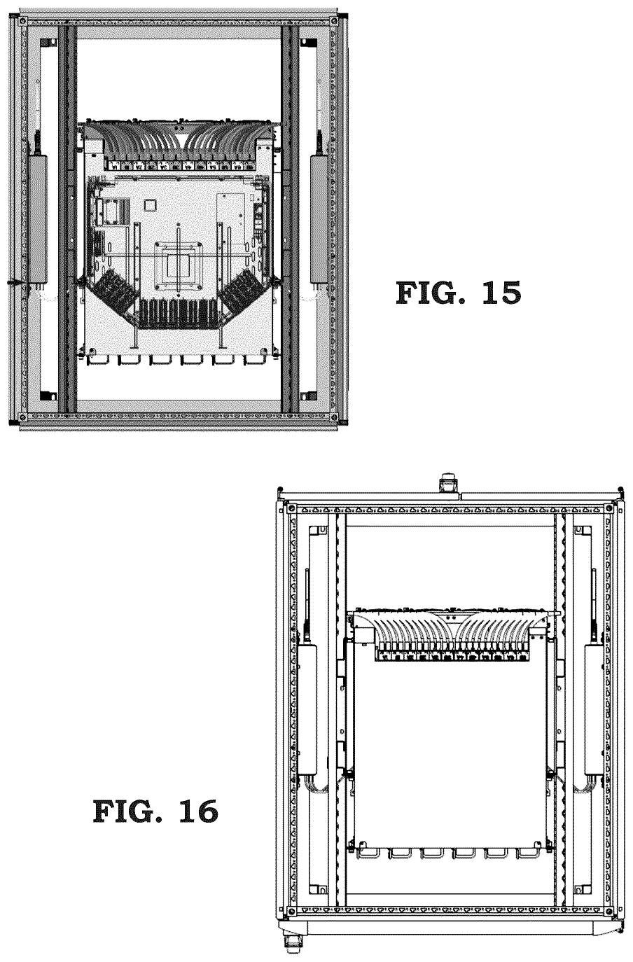

FIG. 15 is a diagram showing a cross-sectional top view of an embodiment of a network component and a corresponding side plane FIM. FIG. 16 is a diagram showing a cross-sectional top view of an embodiment of another network component and corresponding side plane FIM.

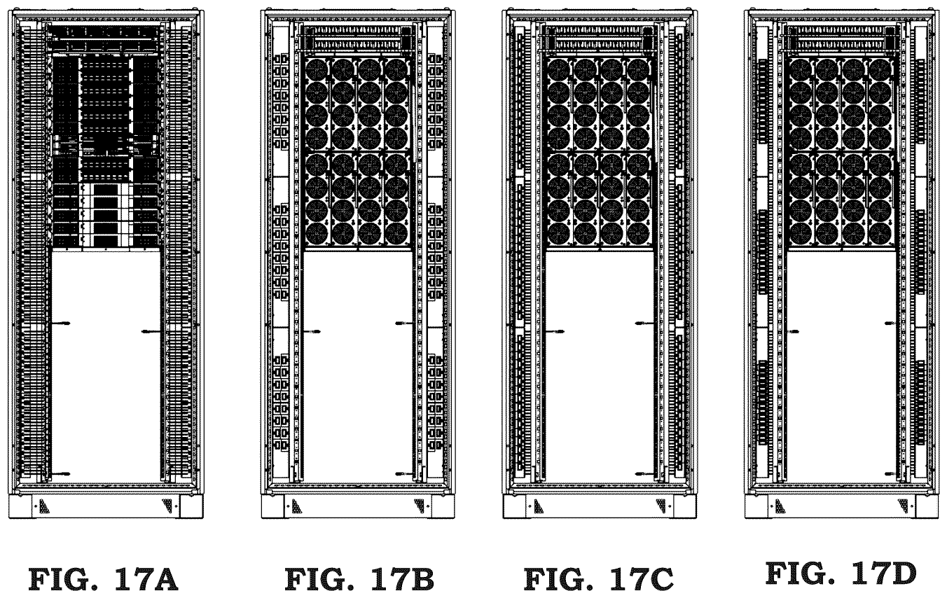

FIG. 17A is a diagram illustrating a front view and FIG. 17B-17D are diagrams showing back views of an embodiment of a rack equipped with network components and side plane FIMs. The front view shows the MPO cable connections, while the back views show the EBO connectors, which are unconnected during the constructions phase and while the racks are being transported to the data center. Again, after shipping, the EBO connectors can be attached to multiple EBO trunk cables for connection to FIMs on other racks.

### Deployment and Installation Method for Multi-Rack Network Node

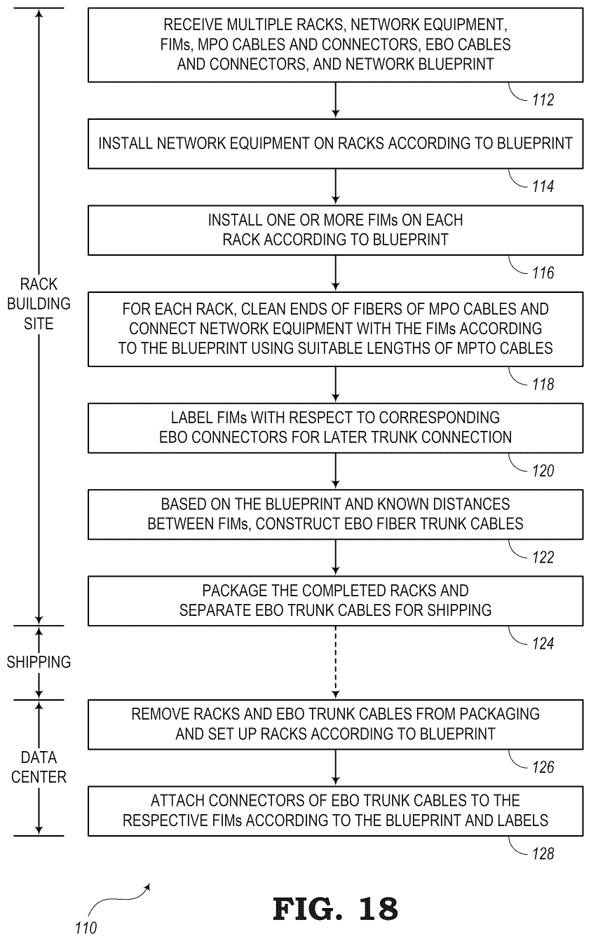

FIG. 18 is a flow diagram illustrating an embodiment of a method 110 for building and setting up a multi-rack node in a data center. Before the method 110, a node engineering design team may be tasked to design the network node according to various criteria. The design phase may result in the network node blueprint that defines various aspects of the network node, such as a) the number racks needed to accommodate the various network modules and other equipment for construction the node, b) the types and locations of the network equipment on various racks, c) a connectivity map showing how all the network modules are connected, which can be either an internal connection (or intra-rack connectivity) or external connection (or inter-rack connectivity). Also, the blueprint may include the actual design or layout of the data center where the network node is configured to be set up and where all the racks might be arranged. The blueprint may also account for the various distances between the network modules where connectivity is needed, including distances between network modules located on different racks. This design phase and blueprint creation may also include consulting with a team working at the data center itself to verify that the expected spaces are truly available for setting up, that the dimensions of the data center are accurate, and other factors that may be needed.

After creating the blueprint, the method 110 includes a first group of steps that may be performed at a first location that may be remote from the data center. Then, after completing this first group of steps, the method 110 includes performing steps at the data center itself.

The first group of steps includes a first step that includes receiving multiple racks, network equipment (e.g., network modules), FIMs, MPO cables and connectors, and EBO cables and connectors, along with the network blueprint, as indicated in block 112. Next, the method 110 includes installing the network equipment on the racks according to the blueprint, as indicated in block 114. Then, the method 110 includes installing one or more FIMs on each of the racks according to the blueprint, as indicated in block 116. For each rack, the method 110 includes cleaning the ends of the fibers of MPO cables as needed and connecting the network equipment with the FIMs according to the blueprint using a suitable length of MPO cables, as indicated in block 118. The method 110 further includes labelling the FIMs with respect to corresponding EBO connectors for later trunk cable connections, as indicated in block 120. Based on the blueprint and known distances between FIMs, the method 110 also includes a step of constructing EBO fiber trunk cables, as indicated in block 122. The method 110 further includes a step of packaging the completed racks and separate EBO trunk cables for shipping, as indicated in block 124.

Again, the second group of steps are configured to be performed at the data center after the packaged racks and trunk cables have been transported there. Thus, the method 110 further includes removing the racks and EBO trunk cables from the packaging and setting up the racks according to the blueprint, as indicated in block 126. Next, the method 110 includes connecting the connectors of the EBO trunk cables to the respective FIMs according to the blueprint and labels, as indicated in block 128.

According to some embodiments, a method for deploying a node may include a step of attaching a plurality of network modules to a rack of a multi-rack network node. The method may further includes a step of installing a Fiber Interface Module (FIM) to the rack. Also, the method may include a step of connecting a first set of cables between the network modules and the FIM. Furthermore, the method may include a step of constructing one or more fiber trunk cables configured to be attached between the FIM and one or more network module mounted on different racks of the multi-rack network node after the rack is shipped to a destination where the multi-rack network node is intended to operate. In some embodiments, the first set of cables, for example, may include Multi-fiber Push-On (MPO) cables, wherein the method may further include a step of cleaning the fiber ends of the MPO cables before connection between the network modules and the FIM.

### EBO Connectors

The Expanded Beam Optics (EBO) connectors, as described in the present disclosure, are generally less sensitive to dust and drastically improve installation time. For example, by being relatively insensitive to dust, the use of EBO connectors can essentially eliminate time-consuming inspection and cleaning procedures. Also, EBO cables and connectors may be configured for high capacity. For example, EBO cables may include 144 fibers per connector, which reduces the number of total connections needed to connect the connectors. Also, it cuts down on time needed for preparing and applying labels and the labor time with respect to the actual mating action.

Also, since some embodiments may may only use 128 fibers per EBO, each EBO-144 will have a spare MPO-16 connection that can be used should one fail for any reason. Furthermore, the density of EBO connectors allows them to face upward to a data center cable trough, which requires less bending and slack storage for thick low-bend-radius trunk cables.

EBO connectors are relatively newer types of connectors. One advantage of EBO connectors is the reduced sensitivity to dust and contamination due to expanded beam optics technology, which significantly reduces or even eliminates the need for fiber cleaning. Also, EBO includes a high fiber density per cable, typically 144 fibers per cable, referred to as “EBO 144.”

### Additional Considerations

According to various implementations, the systems described herein may have certain points of novelty with respect to conventional systems. For example, one area of novelty includes the combination of EBO, MPO-16, and a shuffle function to achieve advantages at a system level. For example, EBO cables with a shuffle function can multiply the radix by eight. Also, cabinet mechanicals can eliminate the need for a separate Vertical Cable Manager to be attached to the rack. In addition, the systems described herein can be adapted to work with angled faceplates.

The FIMs may be fixed in the racks. Also, the MPO cables and connectors may also be constructed where they are also fixed on the racks. Then, after shipping, the connection using the EBO cables can be performed in a simple manner whereby one or two orders of magnitude fewer connections are needed to proper connect the network node. Also, since the EBO cables and connectors do not require the same level of attention with respect to cleaning as MPO connectors and fiber ends, the EBO cables can be connected quickly in the field.

The racks may be constructed in a remote location, preferably a location that is free of dust of other airborne contaminants that can interfere with the fiber ends of the MPO connectors. These MPO connectors may be cleaned in a sterile environment, where the racks are constructed, and packaged. This remote rack-building location may be a third party integrator, which may have sufficient room to combine a plurality of network components.

The system may be a large-scale network node or router system spanning multiple racks. Typically, large router systems are built into multiple racks interconnected with many cables, which can require a great amount of time to set up and connect. A traditional design involves numerous MPO connectors, each requiring meticulous cleaning and handling. A challenge arises because of the large number of MPO cables, which complicates installation and maintenance significantly. Additionally, traditional designs may involve complicated staging and setup procedures, particularly at the data center, where space constraints make handling cumbersome. The systems and methods of the present disclosure are configured to overcome these issues with the conventional systems.

The present disclosure allows for a simplified on-site installation. The most complex MPO connections are handled beforehand at a remote location (e.g., by third party integrators), making rack installation on-site simple and efficient. Also, the present disclosure is configured for Radix Multiplication, which is a scaling advantage, where the shuffle function significantly increases the system's radix, allowing the system to scale up to 8 times more than a traditional design without side plane cabling.

### Network Node and FIM

According to an embodiment, a network node includes a plurality of network modules and one or more Fiber Interface Modules (FIMs). Prior to shipment to a deployment destination, intra-rack fiber connectivity is pre-installed among the network modules and the FIMs using multi-fiber connectors and cables. At the deployment destination, inter-rack fiber connectivity is established by connecting high-density fiber trunk cables between the FIMs located on different racks. This combination of pre-installed intra-rack connectivity and simplified inter-rack connection enhances deployment efficiency and reduces installation complexity.

The multi-fiber connectors and cables used for intra-rack connectivity may include Multi-fiber Push-On (MPO) connectors and cables, or alternatively, other multi-fiber connector types such as Multi-fiber Termination Push-on (MTP) connectors, or fiber ribbon cables. The high-density fiber trunk cables utilized for inter-rack connectivity can include Expanded Beam Optics (EBO) trunk cables and connectors with capacities such as 144 fibers per cable, or alternatively, Ultra-High-Density (UHD) connectors, MXC connectors, or other comparable high-capacity fiber trunk solutions.

Each FIM includes a front section configured for intra-rack connectivity and a back section configured for inter-rack connectivity, facilitating organized cable management and efficient routing. The FIM enclosures may feature either a straight-through fiber lane arrangement for direct connectivity or a shuffled fiber lane arrangement designed to redistribute fiber paths, thereby increasing switch radix, enhancing scalability, and optimizing fiber management.

The network node is particularly suited for deployment in data centers with limited staging areas. Prior to shipment, multi-fiber connectors and cables are cleaned and pre-connected, ensuring cleanliness and signal integrity. High-density fiber trunk cables are typically constructed separately and shipped independently to the deployment destination, featuring custom lengths based on pre-calculated distances between racks, planned rack arrangements, specific facility characteristics, and predetermined slack allowances. Network modules within the node may be divided into groups, with one group configured as fabric components and another group as fabric interface or gateway components, enabling clear functional segregation and improved network organization.

According to another embodiment, a Fiber Interface Module (FIM) used in this system includes an enclosure mountable adjacent to network modules. It features a first set of connectors for intra-rack connectivity, pre-connected to multi-fiber cables prior to shipment, and a second set of connectors for inter-rack connectivity intended for rapid connection after shipment. The connectors within the FIM may be mounted.

### Method

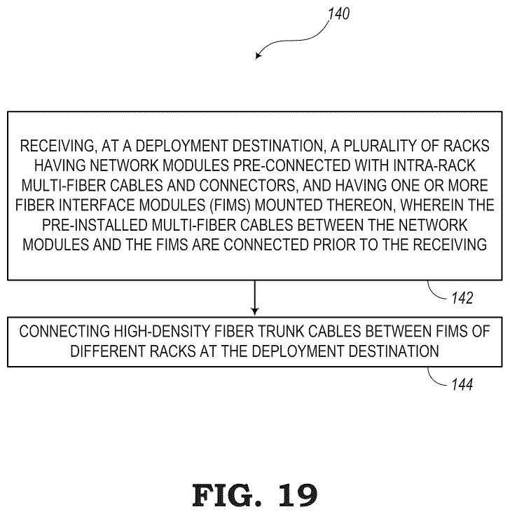

FIG. 19 is a flow diagram illustrating a method 140 for deploying a large-scale network node, according to some embodiments. The method 140 begins with receiving, at a deployment destination such as a data center, a plurality of racks that already have network modules pre-installed and interconnected using intra-rack multi-fiber cables and connectors, along with one or more Fiber Interface Modules (FIMs) mounted thereon. These multi-fiber cables between the network modules and the FIMs are connected and tested prior to shipment, significantly reducing on-site installation effort and complexity, as indicated in block 142. Upon arrival at the deployment destination, high-density fiber trunk cables are connected between FIMs located on different racks, thereby establishing inter-rack connectivity quickly and efficiently, as indicated in block 144.

The intra-rack connectivity typically utilizes Multi-fiber Push-On (MPO) cables due to their compact design and ease of use; however, other suitable multi-fiber cable solutions, such as Multi-fiber Termination Push-on (MTP) or fiber ribbon cables, may also be employed. For inter-rack connectivity, Expanded Beam Optics (EBO) trunk cables and connectors are commonly utilized, often featuring high fiber densities such as 144 fibers per cable, although alternative high-density fiber solutions such as Ultra-High-Density (UHD) connectors or MXC connectors may also be selected based on specific deployment requirements. Additional steps of the method 140 include arranging the racks at the deployment destination according to a predefined, detailed blueprint that ensures optimal spacing, cable management, and airflow. The method 140 can further include verifying connectivity between network modules following the connection of the high-density trunk cables, conducting comprehensive inspections of cable routing and labeling, and performing extensive testing of the deployed network node at the deployment destination to confirm system performance, connectivity, and operational readiness.

### Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A network node comprising:
a plurality of network modules;
one or more Fiber Interface Modules (FIMs);
pre-installed intra-rack fiber connectivity among the plurality of network modules and the one or more FIMs prior to shipment to a deployment destination; and
inter-rack fiber connectivity configured to be established at the deployment destination by connecting fiber cables between the one or more FIMs of different racks,
wherein the intra-rack fiber connectivity utilizes pre-installed multi-fiber connectors and cables, and the inter-rack fiber connectivity is established using high-density fiber trunk cables configured for simplified field installation.

2. The network node of claim 1, wherein the multi-fiber connectors and cables include Multi-fiber Push-On (MPO) cables and connectors.

3. The network node of claim 1, wherein the high-density fiber trunk cables include Expanded Beam Optics (EBO) trunk cables and connectors with a plurality of fibers per cable.

4. The network node of claim 1, wherein each FIM includes a front section for the intra-rack fiber connectivity and a back section for the inter-rack connectivity.

5. The network node of claim 1, wherein the deployment destination is a data center with limited staging area.

6. The network node of claim 1, wherein the multi-fiber connectors and cables are pre-connected prior to the shipment.

7. The network node of claim 1, wherein the high-density fiber trunk cables and connectors are constructed separately.

8. The network node of claim 1, wherein the high-density fiber trunk cables have custom lengths based on one or more of pre-calculated distances between racks, planned rack arrangements, facility characteristics, or predetermined slack.

9. The network node of claim 1, wherein the network modules include a first group configured as fabric components and a second group configured as fabric interface or gateway components.

10. The network node of claim 1, wherein each FIM includes either a straight-through fiber lane arrangement for direct connectivity or a shuffled fiber lane arrangement configured to redistribute fiber paths and increase radix, optimizing fiber management and enhancing scalability.

11. A Fiber Interface Module (FIM) comprising:
an enclosure configured to be mountable adjacent to network modules;
a first set of connectors for intra-rack connectivity pre-connected to multi-fiber cables prior to shipment to a deployment destination; and
a second set of connectors for inter-rack connectivity configured to connect to high-density fiber trunk cables after the shipment to the deployment destination;
wherein the FIM facilitates simplified and efficient deployment through pre-installed intra-rack connectivity and rapid inter-rack connection at the deployment destination.

12. The FIM of claim 11, wherein the first set of connectors comprises Multi-fiber Push-On (MPO) connectors.

13. The FIM of claim 11, wherein the second set of connectors comprises Expanded Beam Optics (EBO) connectors.

14. The FIM of claim 11, wherein the enclosure includes either a straight-through or shuffled fiber lane arrangement configured to increase radix.

15. The FIM of claim 11, wherein connectors are mounted on angled faceplates to improve cable management and reduce fiber bending.

16. A method for deploying a large-scale network node comprising:
receiving, at a deployment destination, a plurality of racks having network modules pre-connected with intra-rack multi-fiber cables and connectors, and having one or more Fiber Interface Modules (FIMs) mounted thereon, wherein the pre-installed multi-fiber cables between the network modules and the FIMs are connected prior to the receiving; and
connecting high-density fiber trunk cables between FIMs of different racks at the deployment destination.

17. The method of claim 16, wherein the intra-rack connectivity utilizes Multi-fiber Push-On (MPO) cable and the inter-rack connectivity utilizes Expanded Beam Optics (EBO) trunk cables.

18. The method of claim 16, further comprising arranging the plurality of racks at the deployment destination according to a predefined blueprint.

19. The method of claim 16, further comprising verifying connectivity between network modules after connecting the high-density fiber trunk cables.

20. The method of claim 16, further comprising testing the network node at the deployment destination to validate system performance and connectivity.
